(19) United States
(12) Patent Application Publication
(10) Pub. No.: US 2014/0067748 A1
(43) Pub. Date: Mar. 6, 2014

(54) SYSTEM AND METHOD FOR OCEAN OBJECT DETECTION

(71) Applicants: John R. Dubberley, New Orleans, LA (US); William M. Sanders, New Orleans, LA (US)

(72) Inventors: John R. Dubberley, New Orleans, LA (US); William M. Sanders, New Orleans, LA (US)

(73) Assignee: THE GOVERNMENT OF THE UNITED STATES, AS REPRESENTED BY THE SECRETARY OF NAVY, Arlington, VA (US)

(21) Appl. No.: 13/775,616

(22) Filed: Feb. 25, 2013

Related U.S. Application Data
(60) Provisional application No. 61/608,878, filed on Mar. 9, 2012.

(51) Int. Cl. G06N 7/00

(52) U.S. Cl. CPC G06N 7/005
USPC 706/52

(57) ABSTRACT

System and method for discriminating buried clutter from munitions through exploitation of unique clutter/target signatures and characteristics detected from advanced acoustic and magnetic sensors.

### CROSS-REFERENCE TO RELATED APPLICATIONS

This Application is a non-provisional application claiming priority to provisional application #61/608,878 filed on Mar. 9, 2012, under 35 USC 119(e). The entire disclosure of the provisional application is incorporated herein by reference.

### BACKGROUND

Methods and systems disclosed herein relate generally to mine detection, and more specifically to techniques that can discriminate between buried underwater munitions and buried clutter.

Before the Department of Defense can turn over closed bases to civilian use, the land and waterways must be cleared of all unexploded ordinance (UXO) that might endanger civilians using the sites. Over land there are time-consuming methods for remediating discontinued firing ranges. However, these methods do not work in the marine environment.

As a result of former military training, weapons testing, or inadvertent unloading, unexploded ordnance (UXO) is present in many coastal, riverine, and estuarine environments throughout the world. Increasingly, people are using these areas for commercial, residential, and recreational purposes. Detecting and characterizing UXO in these underwater environments can be challenging whether they are buried or proud. However, in spite of the recent advances in UXO detection performance, false alarms due to clutter still remain a serious problem. Because the cost of identifying and disposing of UXO in the United States using current technologies is estimated to range up to $500 billion, increases in performance efficiency due to reduced false alarm rates can result in substantial cost savings. The current sonar classification methods are two-dimensional.

Referring now to FIG. 1, acoustic scattering from buried cylindrical objects 11 has been investigated using time-frequency analysis techniques, such as Wigner-Ville distributions. These methods were used to analyze information available for classification of targets, using both simulated and actual data from targets buried in sand in a tank. It was found that practical constraints common to bottom penetrating systems (limited bandwidth, temporal separation from surface returns, low signal-to-noise ratio) result in a severely limited amount of information to analyze. When scattering off targets in water, without the constraints of dealing with buried objects, much more detailed information (more spectral resonances and nulls, or more distinct echoes) would be available, making characterization of an object relatively robust. However, there is a paucity of information. For the smallest objects, there was little evidence that there were elastic interactions at all, making discrimination from naturally occurring point scatters (clutter) virtually impossible, given the bandwidth and power constraints for that sonar. Even for larger targets, where elastic interactions were evident, there were still a limited number of features available for classification.

UXO has been searched for using either purely acoustic techniques through bottom penetrating sonar or magnetically searching for metallic anomalies. Purely magnetic surveys may not image the bottom object so all that was known was that a magnetic object with a certain amount of metal was present. Acoustic imagery through bottom penetrating sonar could find hard objects buried in the bottom and infer the shape of the object but had little ability to distinguish between items of interest and rocks, jetsam, and coral heads. Combining the two methods in a systematic way could lower the level of false positives.

A three-dimensional system and method are needed for detection and classification of buried proud bottom objects and partially buried underwater objects.

### SUMMARY

The automated system and method of the present embodiment discriminate buried underwater munitions from buried clutter. The system includes, but is not limited to including, a clutter classifier that uses characteristics of buried munitions and clutter derived from acoustic and magnetic signatures. Distinguishable characteristics between munitions and clutter are discovered through controlled experiments. Bayesian inference is used in the present embodiment to fuse various detection sensors. A Support Vector Machine (SVM) classifier receives the past fused detections, and examines feature vectors in, or derived from, the detection sensors. The classifier can separate unexploded ordnance (UXO) from UXO-like targets. UXO signatures can be used to calibrate the system of the present embodiment in an underwater test facility. The method of the present embodiment can be tested using parametric sonar and magnetic surveys conducted over inert munitions and clutter placed in different sediments types and at different sub-bottom depths.

The improved discrimination techniques developed through this effort can reduce time, effort, and thus operational costs associated with typical underwater UXO remediation efforts. By more accurately identifying clutter, the false detection rate can be reduced allowing for more efficient recovery of munitions. New sub-bottom sensors are capable of improved detection of UXO; however, they also detect increased amounts of clutter, driving the need for improved clutter discrimination techniques. The use of the chained multi-sensor Bayesian detector with the support vector machine allows the system to automatically fuse the detections from all available systems to greatly lower the number of false detections each system can detect alone and improve the classification by eliminating spurious detections.

Inputs to the system can include, but are not limited to including, submarine profiler, parametric sonar, side scan sonar, magnetic sensors, and laser views of the bottom. The present embodiment includes a multi-sensor Bayesian detector designed to achieve a low rate of missed detections, while allowing (momentarily) a high false alarm rate, thereby providing a potential targets to processing computer code. The Bayesian detector uses the inputs and threshold values. Support vector machine (SVM) classifiers can be used to classify the targets as munitions or non-munitions.

Included in the present embodiment is a classification framework for underwater features of interest based on the statistical classifiers that can be used to determine maximum separation classes in a feature space formulation of a feature-based dataset. Common machine learning classifiers can include, but are not limited to including, back-propagation neural networks (BPNN) and SVM. Performance of a classifier can be improved by aggregating modalities and designing an optimal feature space to describe individual features, in this case, underwater clutter objects of interest. This classification framework can combine the downward-looking sonar imagery with extrapolated morphology and with other available imagery as a feature space. Characteristics to be considered for feature vectors can include object size, first order shape, volume, return intensity, first order structural resonance, pixel statistical distribution, acoustic penetrability, windowed texture coefficients, and magnetic response. This feature space can improve the classifier's ability to discriminate among morphology classes, such as man-made objects and natural formations.

Each proposed classifier can be evaluated with the following metrics: traditional receiver operating characteristics (ROC) curves to plot probability of detection versus probability of false alarm for a given classifier characteristic, confusion matrices to show the skill of various feature set classifiers, and balanced success ratio. Balanced success ratio, BSR=[P(success|+)+P(success|−)]/2, where 50% of the scoring is the percent of real targets correctly classified and 50% of the scoring is the percentage of called targets that are real targets. This is useful in the case where the amount of clutter objects detected is much greater than the number of objects to detect in each category. The present embodiment can significantly improve the ability to characterize and remediate small (20 mm) to large (2000 lb) munitions existing at numerous underwater sites in depths up to 120 feet.

### BRIEF DESCRIPTION OF THE DRAWINGS

FIG. 1 is a screen shot of a grey-scale depiction of cylindrical objects found in sediment;

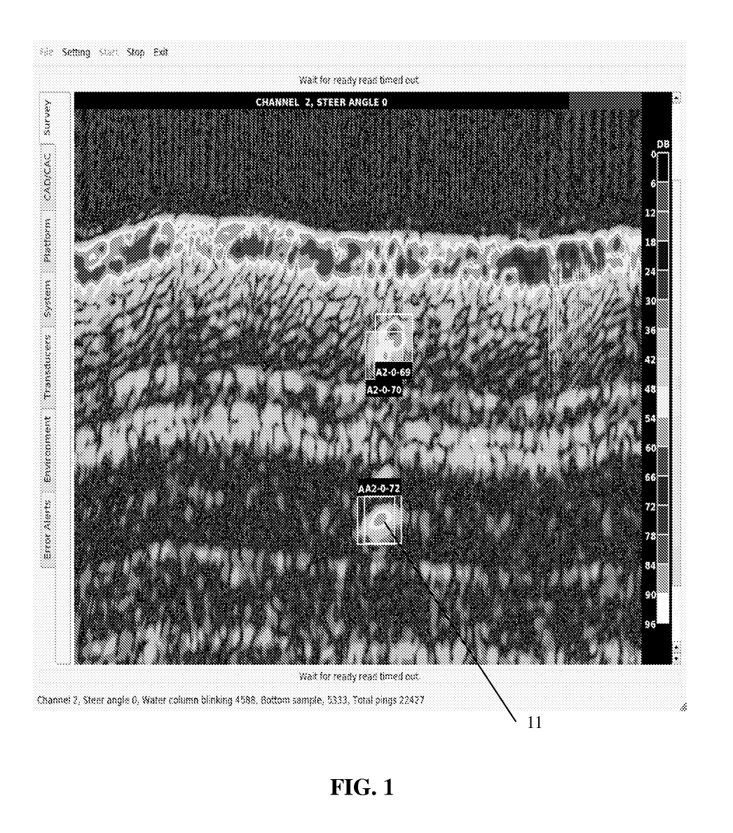

FIG. 2 is a graphical depiction of notional elements of Bayesian inference;

FIG. 3 is a graphical depiction of notional elements of SVM;

FIG. 4 is a flowchart of the method of the present embodiment; and

FIG. 5 is a schematic block diagram of the system of the present embodiment for discriminating buried munitions from clutter by exploiting acoustic and magnetic signatures.

### DETAILED DESCRIPTION

The problems set forth above, as well as, further and other problems are solved by the present teachings. These solutions and other advantages are achieved by the various embodiments of the teachings described herein below.

Bayesian inference is a method of combining inputs from different sources to choose the most likely of a set of two (or more) hypothetical options. It is an optimal weighting of the inputs that minimizes the risk of making a wrong decision, based on a prior assessment of probabilities of the separate hypotheses and the relative importance of the various outcomes. The Bayesian framework can be applied to the detection and classification problem separately, or as a single inference problem. The result of a Bayesian inference solution is not just the choice of the most likely hypothesis, but an assessment of the probability of each possible outcome. Hence, treatment of uncertainty is a natural element of Bayesian inference.

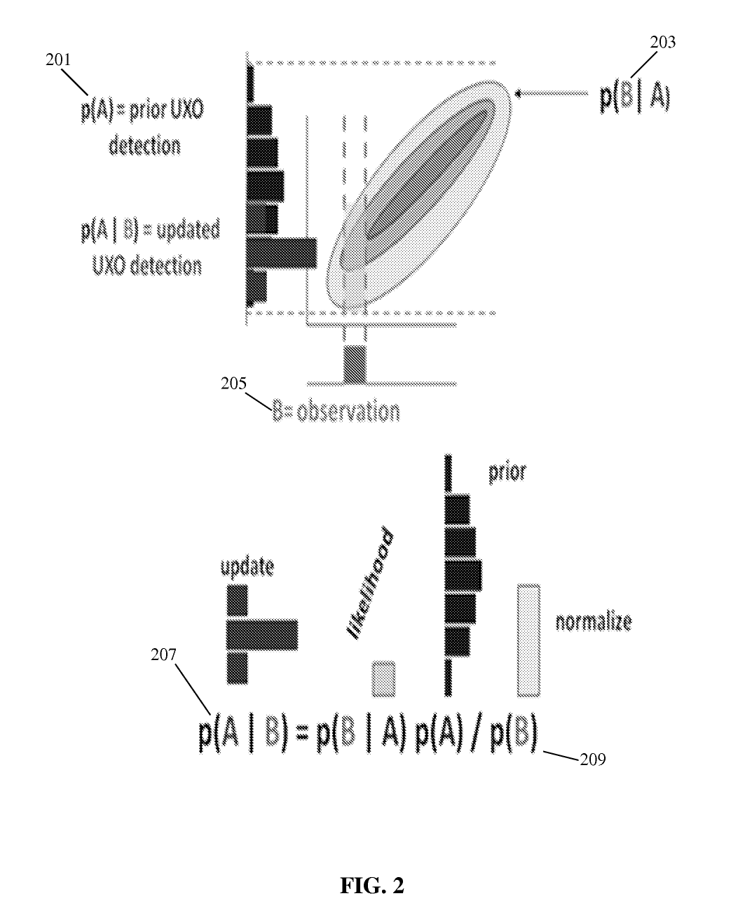

Referring now to FIG. 2, the notional elements of Bayesian inference are shown. Given some prior knowledge of the likelihood of a hypothesis A being true p(A) 201, an observation B 205 and the conditional probability distribution function p(B|A) 203, an updated probability distribution of the likelihood of A being true, p(A|B) 207, (given the observation B 205) can be computed. The conditional probability distribution function p(B|A) 203 is usually formulated through some knowledge of the statistics of the problem. In the case of a quadratic detector, the distribution is taken to be Chi-squared distributed, with mean level determined by the signal-to-noise ratio. p(B) 209 is the probability of the observations, a normalizing factor.

A test-bed can be constructed that uses Bayesian inference to separately treat the detection, localization and classification capabilities within a reconfigurable multi-sensor network. For any configuration, a maximum likelihood detector can be constructed, localization estimation errors and errors in feature vector estimated can be minimized.

SVM classification algorithms, as have been used in medical imaging, taking advantage of the feature vectors calculated by the detection sensors, can be used in the present embodiment. Feature vectors may include magnetic properties, surface expressions detected in sidescan imagery or sea floor characteristics derived from the side scan imagery, and optical imagery when available. Using a known training set developed in the test field, the object characteristics can be clustered into UXO categories (e.g. 105 mm shell) and non-UXO bottom object (e.g. anchors, oil drums, or pipes) categories in a randomly chosen 90% of the available data. The classifiers' performance on the remaining 10% of the data can be used as a metric to score the skill of each classifier. New detected objects can be classified by their closeness of fit to each grouping. Grouping centroids can be adjusted dynamically as new data are entered.

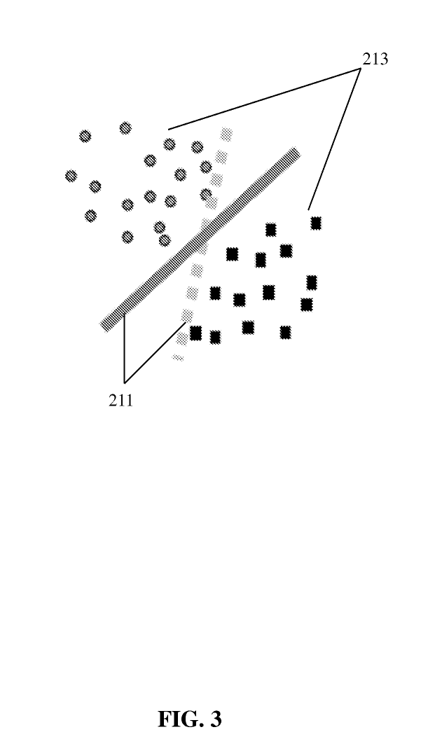

Referring now to FIG. 3, a notional diagram for a support vector machine is shown. Several planes 211 can separate the two groups 213 of objects. The algorithm chooses the plane 211 with maximum margin for both groups.

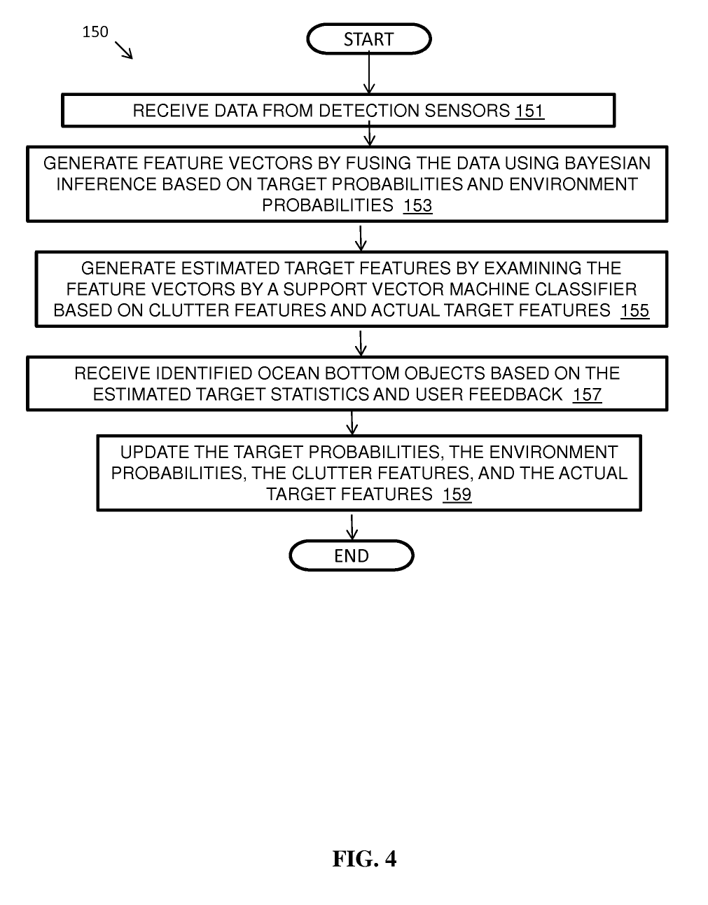

Referring now to FIG. 4, method 150 for detection and classification of ocean bottom objects can include, but is not limited to including receiving 151 data from detection sensors, generating 153 feature vectors by fusing the data using Bayesian inference based on target probabilities and environment probabilities, the Baysian inferred sensor fusion eliminating many candidate targets before generating 155 estimated target features by examining the feature vectors by a support vector machine classifier based on clutter features and actual target features, receiving 157 identified ocean bottom objects based on the estimated target statistics and user feedback, and updating 159 the target probabilities, environment probabilities, the clutter features, and the actual target features. Method 150 can optionally include generating long-term statistics by support vector machine classifier, determining clutter features from the long-term statistics, providing the clutter features to the multi-sensor classifier, and selecting sensors from a group consisting of parametric sonar and magnetic surveys. Determining the clutter features can include, but is not limited to including, classifying clutter based on characteristics of the ocean bottom objects derived from acoustic and magnetic signatures. The ocean bottom objects can include, but are not limited to including, unexploded ordinance.

An alternate method for discriminating buried clutter from munitions through exploitation of unique clutter/target signatures and characteristics detected from advanced acoustic and magnetic sensors can include, but is not limited to including, weighting, by a Bayesian detector, sensor data (for example, but not limited to, sidescan, synthetic aperture sonar, sub-bottom profiler, magnetic data, and optical data) detections using a prior knowledge embodied in, for example, a target data base to optimally filter the detections for lowest possible false alarm rate while still detecting 95% of the detectable UXO. The alternate method can also include extracting feature vectors (characteristics of the detected object either sensed or derived from the sensor data) from the weighted sensor data, classifying the feature vectors, using the support vector machine, into the various munition types expected to be found in the location, and feeding estimated successful detects into an environmental data base of detections for that environment, the environmental data base being available to the multi sensor Bayesian detector.

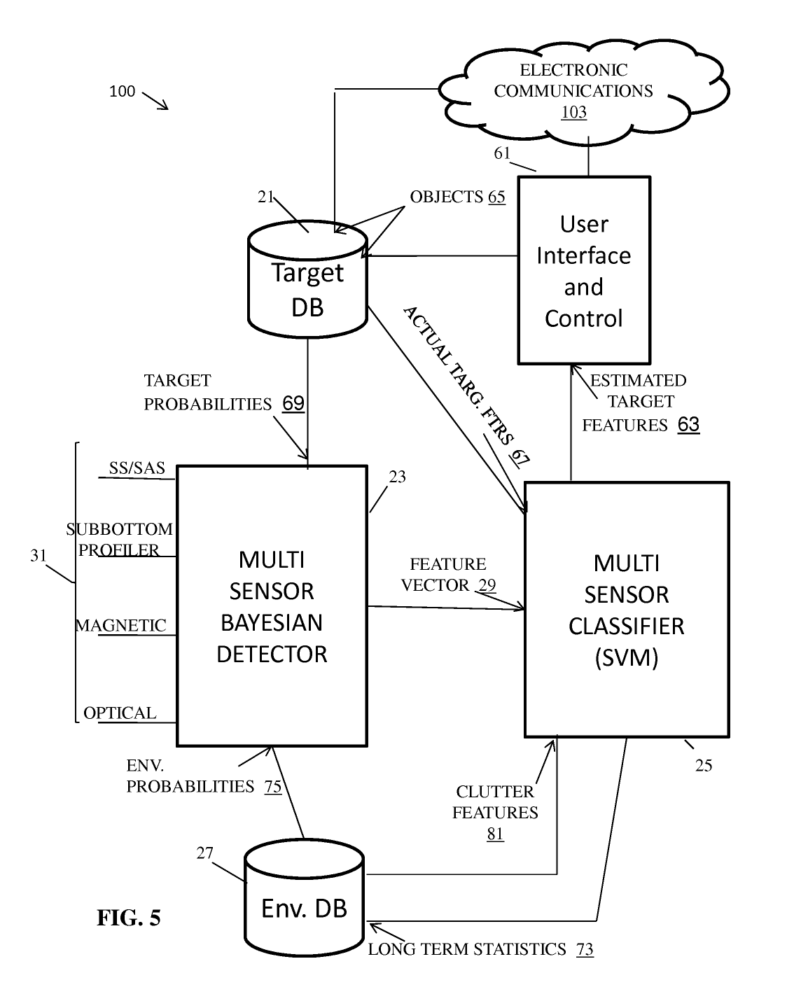

Referring now to FIG. 5, system 100 for detection and classification of ocean bottom objects can include, but is not limited to including, multi-sensor Bayesian detector 23 receiving data from detection sensors 31 and generating feature vectors 29 by fusing the data using Bayesian inference based on target probabilities 69 and environment probabilities 75. System 100 can also include multi-sensor classifier support vector machine 25 generating estimated target features 63 by examining feature vectors 29 by a support vector machine classifier based on clutter features 81 and actual target features 67. System 100 can still further include target database 21 receiving identified ocean bottom objects 65 directly or through, for example, but not limited to, electronic communications 103, based on estimated target features 63 and user input 61, generating actual target features 67, and updating target probabilities 69 based on estimated target statistics 63 and user input 61. System 100 can also include environment database 27 receiving long-term statistics 73 about objects 65 from multi-sensor classifier support vector machine 25, generating clutter features 81, and updating environment probabilities 75.

An alternate system for discriminating buried clutter from munitions through exploitation of unique clutter/target signatures and characteristics detected from advanced acoustic and magnetic sensors can include, but is not limited to including, multi-sensor Bayesian detector 23 (FIG. 5) weighting detections from sensor data 31 (FIG. 5) (Sidescan, Synthetic Aperture Sonar, Sub-bottom profiler, magnetic data, and optical data) using a prior knowledge target data base 21 (FIG. 5) to optimally filter the detections for lowest possible false alarm rate while still detecting 95% of the detectable UXO. Multi-sensor Bayesian detector 23 (FIG. 5) can also extract feature vectors 29 (FIG. 5) (characteristics of the detected object either sensed or derived from the sensor data 31 (FIG. 5)) from the weighted sensor data. The alternate system can also include multi-sensor classification support vector machine 25 (FIG. 5) classifying feature vectors 29 (FIG. 5) into the various munition types expected to be found in the location, and feeding successful detections, based on estimated target features 63 (FIG. 5) and user input 61 (FIG. 5), into environmental data base 27 (FIG. 5) for the environment associated with the estimated target features to tune multi sensor Bayesian detector 23 (FIG. 5). Multi-sensor Bayesian Detector 23 (FIG. 5) can extract and manipulate (for example, through signal processing) sensor data, can fuse multisensory data, for example, weighting data from each sensor to minimize the risk of making a wrong decision, can perform binary detection involving comparing current observations to archived data by characterizing both known targets from target database 21 (FIG. 5) and the environment from environment database 27 (FIG. 5), can form feature vectors 29 (FIG. 5), and can pass feature vectors 29 (FIG. 5) to multi-sensor classifier support vector machine 25 (FIG. 5). Bayesian network software packages such as, for example, but not limited to, NETICA® from Norsys Software Corporation can be used in the present embodiment for databasing and inferencing (binary detection).

Raw data and results from the computations of the systems and methods present embodiments can be stored for future retrieval and processing, printed, displayed, transferred to another computer, and/or transferred elsewhere. User interface and control 61 (FIG. 5), for example through electronic communications 103 (FIG. 5), can provide objects 65 (FIG. 5) to target database 21. Electronic communications 103 (FIG. 5) can be wired or wireless, for example, using cellular communication systems, military communications systems, and satellite communications systems. Any software required to implement the system can be written in a variety of conventional programming languages. System 100 (FIG. 5), including any possible software, firmware, and hardware, can operate on a computer having a variable number of CPUs. Other alternative computer platforms can be used. The operating system can be, for example, but is not limited to, WINDOWS® or LINUX®.

Referring again primarily to FIG. 4, method 150 (FIG. 4) can be, in whole or in part, implemented electronically. Signals representing actions taken by elements of system 100 (FIG. 5) and other disclosed embodiments can travel over at least one live communications network 103 (FIG. 5). Control and data information can be electronically executed and stored on at least one computer-readable medium such as, for example, target database 21 (FIG. 5) and environmental database 27 (FIG. 5). System 100 (FIG. 5) can be implemented to execute on at least one computer node in at least one live communications network. Common forms of at least one computer-readable medium can include, for example, but not be limited to, a floppy disk, a flexible disk, a hard disk, magnetic tape, or any other magnetic medium, a compact disk read only memory or any other optical medium, punched cards, paper tape, or any other physical medium with patterns of holes, a random access memory, a programmable read only memory, and erasable programmable read only memory (EPROM), a Flash EPROM, or any other memory chip or cartridge, or any other medium from which a computer can read.

Although the present teachings have been described with respect to various embodiments, it should be realized that these teachings are also capable of a wide variety of further and other embodiments.

What is claimed is:

1. A method for detection and classification of ocean bottom objects comprising:
receiving data from detection sensors;
generating feature vectors based on fusing the data using Bayesian inference, the Bayesian inference being based on target probabilities and environment probabilities, the Bayesian inferred fusing of the data eliminating a portion of the data;
generating estimated target features based on an examination of the feature vectors by a support vector machine classifier, the support vector machine classifier being based on clutter features and actual target features;
receiving identified ocean bottom objects based on the estimated target features and user feedback;
updating the target probabilities, the environment probabilities, the clutter features, and the actual target features based on the identified ocean bottom objects; and
detecting and classifying the ocean bottom objects based on the updated target probabilities, the environment probabilities, the clutter features, and the actual target features.

2. The method as in claim 1 wherein the ocean bottom objects comprise unexploded ordinance.

3. The method as in claim 1 further comprising:
generating long-term statistics based on the support vector machine classifier;
determining the clutter features based on the long-term statistics; and
providing the clutter features to a multi-sensor classifier.

4. The method as in claim 3 wherein determining the clutter features comprises:
classifying clutter based on characteristics of the ocean bottom objects derived from acoustic and magnetic signatures.

5. The method as in claim 1 further comprising:
selecting the detection sensors from a group consisting of parametric sonar and magnetic surveys.

6. A system for discriminating buried clutter from munitions comprising:
a multi-sensor Bayesian detector weighting candidate munitions from sensor data based on a target data base, the multi-sensor Bayesian detector extracting feature vectors from the weighted candidate munitions; and
a multi-sensor classification support vector machine classifying the feature vectors into munition types, the multi-sensor classification support vector machine determining candidate munitions, the multi-sensor classification support vector discriminating the munitions from the candidate munitions, the multi-sensor classification support vector machine providing the munitions to an environmental data base, the environmental database tuning the multi-sensor Bayesian detector.

7. The system as in claim 6 wherein the sensor data comprises data gathered from any of sidescan sonar, synthetic aperture sonar, subbottom profiler, magnetic data collectors, and optical data collectors.

8. The system as in claim 6 wherein the feature vectors comprise characteristics of the candidate munitions, the characteristics being sensed from the sensor data.

9. The system as in claim 6 wherein the feature vectors comprise characteristics of the candidate munitions, the characteristics being derived from the sensor data.

10. A system for identifying ocean bottom objects comprising:
a multi-sensor Bayesian detector receiving data from detection sensors and generating feature vectors by fusing the data based on Bayesian inference, the Bayesian inference being based on target probabilities and environment probabilities;
a multi-sensor classifier support vector machine generating estimated target features based on an examination of the feature vectors by a support vector machine classifier, the examination being based on clutter features and actual target features;
a target database receiving the identified ocean bottom objects based on the estimated target features and user input, the target database providing actual target features, the target database providing updated of the target probabilities based on the estimated target statistics and the user input; and
an environment database receiving long-term statistics from the multi-sensor classifier support vector machine, the environment database providing the clutter features to the multi-sensor classifier support vector machine and the environment probabilities to the multi-sensor Bayesian detector.
